(19) United States
(12) Patent Application Publication
(10) Pub. No.: US 2015/0114192 A1
(43) Pub. Date: Apr. 30, 2015

(54) PNEUMATIC BIOMASS CORING MACHINE

(71) Applicant: POET Research, Inc., Sioux Falls, SD (US)

(72) Inventors: Todd L. Peterson, Brandon, SD (US); Alex C. Johnson, Valley Springs, SD (US)

(73) Assignee: POET Research, Inc., Sioux Falls, SD (US)

(21) Appl. No.: 14/061,947

(22) Filed: Oct. 24, 2013

(51) Int. Cl. G01N 1/08

(52) U.S. Cl. CPC G01N 1/08
USPC 83/23; 83/115

(57) ABSTRACT

A core sampling system for removing sample cores of material from biomass bales, which includes a base member, a supporting member extending from and moveable relative to the base member, and a rotatable corer extending from the supporting member. The rotatable corer includes a first elongated tube at least partially surrounding a second elongated tube and a distal tip extending from a distal end of the second elongated tube. The system also includes a transport tube in communication with an inner area of the second elongated tube.

### TECHNICAL FIELD

The present invention relates generally to sampling of material that is provided in a bale, and more particularly relates to removing samples of biomass material from biomass bales.

### BACKGROUND

Materials such as grain and sugar cane can be processed and deposited into the back of an open top truck for transportation to locations where those materials will be further processed or utilized in some other manner. When the material reaches its destination, it is common for the receiver of the material to collect and analyze one or more samples of the material contained in the truck, such as to verify that the contents meet the desired specifications for the material. Because the material is relatively loosely contained within the open top truck, the equipment used to remove the samples of material can include vacuum system tips, such as in the form of grain probes that can pull loose material into an inner probe area to create a plug or core of the material. This plug or core of material can then be removed from the probe and conveyed to a testing location. In another example, coring systems that are utilized in the sugar cane industry can include a device that penetrates the sugar cane that is contained within an open top truck, and then retains the sample within the probe. The sample of sugar cane can then be removed from the probe by pushing it from the corer with a ram or other device, after which the sugar cane can be taken to a testing area so that it can be sampled and/or analyzed.

Another material that is moved in large quantities from one location includes biomass, which is a heterogeneous mixture of biological material. Biomass can consist of plant material, vegetation, and/or agricultural waste or other materials. In order to transport such biomass material, volumes of biomass are often bundled into bales and placed on the back of trucks, such as flatbed trucks. The bales are then transported to locations where the biomass can be used as a renewable energy source, such as for direct use in combustion processes to produce heat, or for indirect use after converting it to a form of biofuel. One common form of biomass is cellulose or cellulosic biomass, which can be made into a clean-burning, high octane fuel, such as cellulosic ethanol. As with the materials described above that are shipped in a relatively loose condition, before the bales of biomass can be used in the facilities to which they are delivered, it is may sometimes also be desirable for the biomass received by a customer to be sampled to verify its composition, check for contaminants, and the like. There is therefore a need to provide sampling systems and devices that can remove samples of biomass from bales, and it is further desirable to provide sampling systems and devices that can remove samples from bales while they are on a truck, and then convey that material to a test lab for testing of the material contained therein.

### SUMMARY

An embodiment of a coring system of the invention includes a rotating corer that is activated by a motor, which can include a number of different types of motors, such as a hydraulic motor, an electric motor, an air-driven motor, and the like. The end of the rotating corer houses a tip that is specifically configured for cutting and penetrating a relatively solid bale of biomass material. The tip is removably affixed to the end of the corer, such as via a threaded connection, so that it can be easily removed and replaced, as desired, which can be useful when it is desired to replace or sharpen the cutting teeth. One manner of holding a corer in place is with pillow block bearings, wherein the assembly is attached to a hydraulically controlled arm that allows a remote operator to position the corer over a bale that is ready to be tested. The arm is then lowered while the corer continues to rotate, thereby allowing the rotating corer to penetrate the biomass material bale.

As the corer penetrates the biomass bale, the biomass immediately adjacent the corer is loosened and a pneumatic airstream is able to remove the biomass material via vacuum. The material is then moved to a transport line and cyclone to a technician who can then perform testing and analysis on the removed core of biomass material. With such a system, it is possible to remotely sample a biomass bale and deliver the material to a technician that is located in another nearby location, such as a scale house.

In an aspect of the invention, a core sampling system is provided for removing sample cores of material from biomass bales, which system includes a base member, a supporting member extending from and moveable relative to the base member, and a rotatable corer extending from the supporting member. The rotatable corer includes a first elongated tube at least partially surrounding a second elongated tube and a distal tip extending from a distal end of the second elongated tube. The system further includes a transport tube in communication with an inner area of the second elongated tube. The rotatable corer may be controlled with a hydraulic motor. The distal tip of the corer may be removably attached to the distal end of the second elongated tube, may include a tapered outer surface, and/or may include a plurality of cutting surfaces spaced from each other around a circumference of the corer.

In an aspect of the invention, a method is provided for extracting samples of biomass material from biomass bales. The method includes the steps of positioning a coring system adjacent to a biomass bale, wherein the coring system includes a base member, a supporting member extending from and moveable relative to the base member, and a rotatable corer extending from the supporting member. The corer comprises a first elongated tube at least partially surrounding a second elongated tube and a distal tip extending from a distal end of the second elongated tube. The system further includes a transport tube in communication with an inner area of the second elongated tube. The steps of the method further include activating the coring system so that the rotating corer rotates, moving the corer toward the biomass bale until the corer contacts the bale, penetrating the bale with the corer to a specified depth, thereby producing a biomass sample core, and transporting the biomass sample core to a testing location.

### BRIEF DESCRIPTION OF THE DRAWINGS

The present invention will be further explained with reference to the appended Figures, wherein like structure is referred to by like numerals throughout the several views, and wherein:

FIG. 1 is a front view of a coring system of the invention;

FIG. 2 is a top view of the coring system illustrated in FIG. 1;

FIG. 3 is a side view of the coring system illustrated in FIG. 1;

FIG. 4 is a perspective, partial sectional view of an embodiment of a corer of the coring systems of the invention;

FIG. 5 is a perspective, partial sectional view of the distal end of the corer illustrated in FIG. 4; and

FIG. 6 is a perspective sectional view of the proximal end of the corer illustrated in FIG. 4.

### DETAILED DESCRIPTION

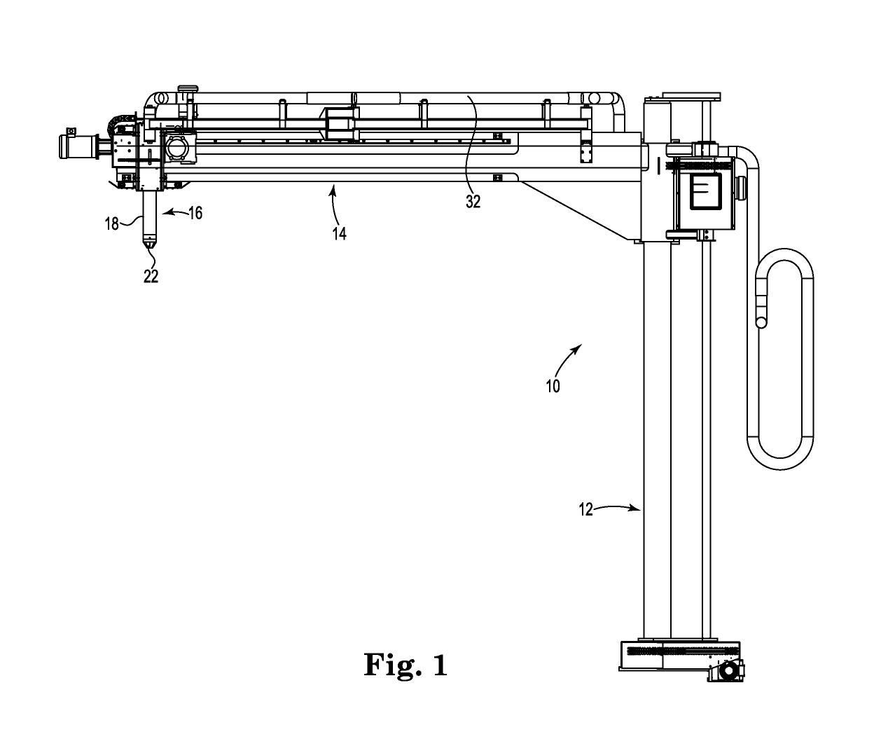

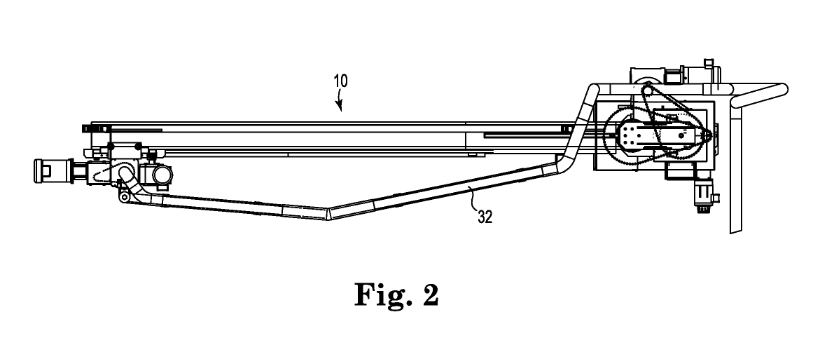

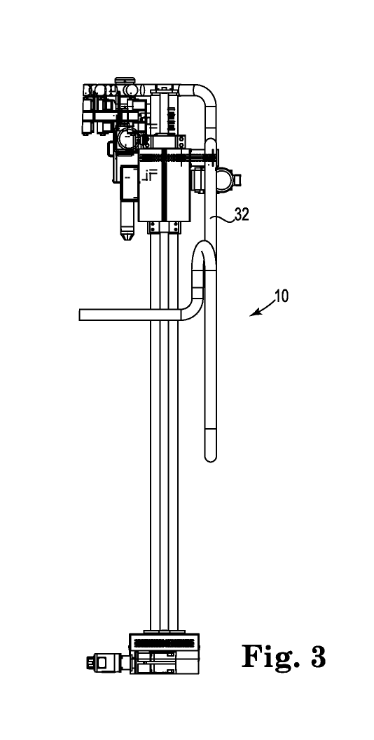

Referring now to the Figures, wherein the components are labeled with like numerals throughout the several Figures, and initially to FIGS. 1-3, one exemplary configuration of a coring system 10 is illustrated, which generally includes a vertical portion 12 from which a horizontal portion 14 extends. A corer 16 extends vertically downward from a distal end of the horizontal portion 14. As described herein, the terms “vertical” and “horizontal” are intended to be relative terms to describe the configuration illustrated; however, it is understood that the system and its components can be tilted, angled, or otherwise arranged relative to each other in operation to access bales of material that are to be sampled. It is further understood that while the vertical and horizontal portions can be arranged to be perpendicular to each other, these portions can instead be arranged at an angle greater or less than 90 degrees relative to each other.

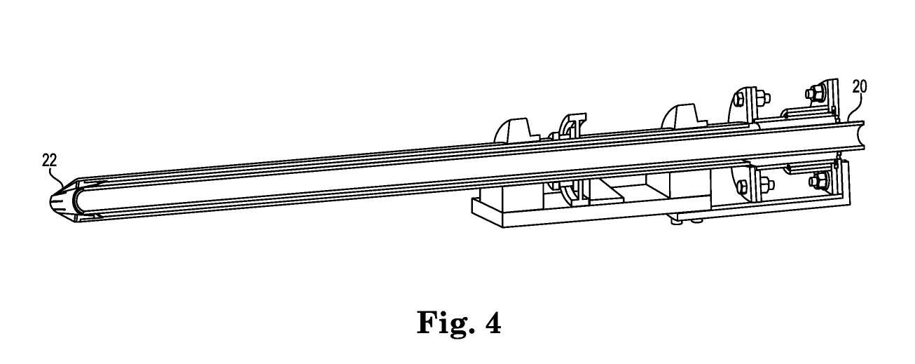

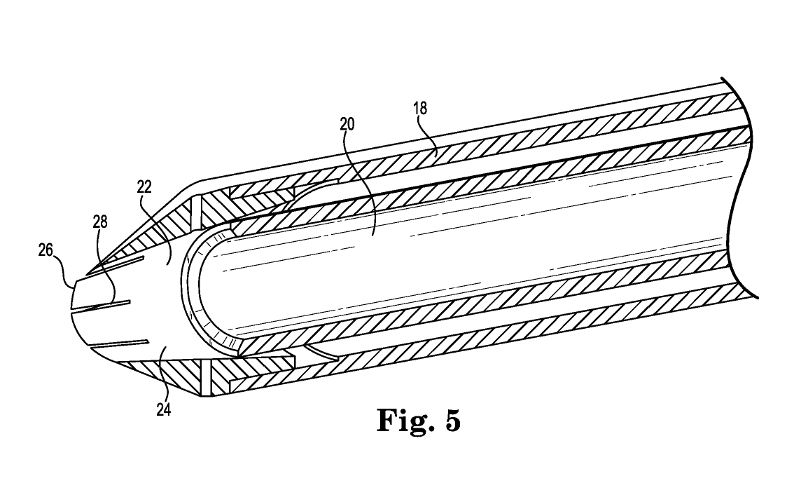

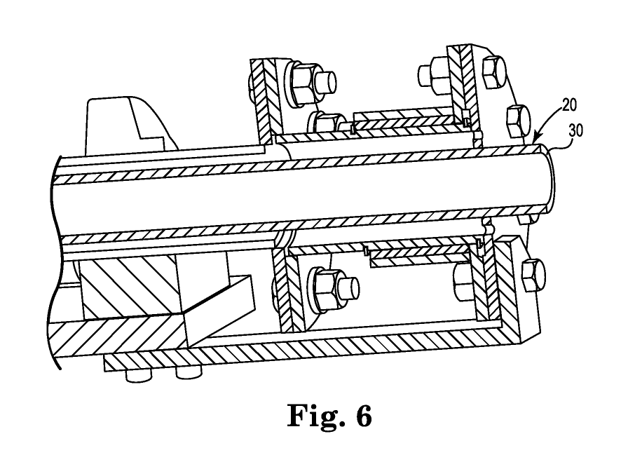

Referring also to FIGS. 4-6, the corer 16 generally comprises an elongated outer tube 18 and an elongated inner tube 20. The outer and inner tubes 18, 20 are arranged so that air can flow freely between them, so that a steady air supply can convey cut material (i.e., a core of material) to a destination, as is described below. The corer 16 is the component of the coring system 10 that actually contacts the material to be sampled, and in an embodiment of the invention, the corer 16 is rotatable to provide for easier penetration of the bale material. The speed of rotation of the corer can be controlled remotely via electronic controls and/or can have physical switches or components that can be adjusted or set to provide for a desired rotation speed.

Inner tube 20 includes a cutting tip 22 that extends from its distal end 26. As shown, the cutting tip 22 includes a tapered outer surface 24 that tapers from a larger diameter to a smaller diameter when moving toward its distal end 26. Such a taper is optional, and it is contemplated that the tip may instead have walls that are parallel to each other, such as in a cylindrical configuration, for example. The tip 16 may further be provided with at least one slot 28, each of which extends in a longitudinal direction and includes an open portion at the distal end 26 of cutting tip 22. The surfaces of the distal tip 16 between adjacent slots 28 define the cutting surfaces of the cutting tip that will be used to penetrate the bale material. As shown, the distal end 26 includes a generally circular periphery and is designed to have a diameter or outer periphery that is similar to the desired diameter of a core that it will be used to remove from a bale. With a circular shape for the distal end 26, the core that is removed from the bale will be generally cylindrical and will have a length that is approximately the same as the distance that the corer will be inserted into the bale. Distal end 26 may alternatively have a shape other than circular, such that the end may instead be oval, elliptical, square, or irregularly shaped. In such cases, it is possible for the corer 16 to vibrate or otherwise move in a repetitive manner to allow the corer 16 to penetrate the bale.

The inner tube 20 extends from its distal end 26 in a proximal direction toward the horizontal member, and includes a proximal end 30. Proximal end 30 is hollow and includes an opening that communicates with other components of the system 10. In particular, the proximal end 30 of inner tube 20 is connected either directly or indirectly to a transport tube 32, an exemplary configuration of which is illustrated in FIGS. 1-3. The tube 32 has a diameter that is at least as large as the core of material that can be cut by the cutting tip 22. In this way, a core of material that is cut by the corer will be held within the length of the corer 16 until it is desired to move it to another location, such as testing location. At the testing location, a vacuum can pull the core of material from the corer 16 into the transport tube 32. The size and shape of the tube should therefore be configured so that the core of material can move freely through the length of the tube 32.

Transport tube 32 extends along the length of the horizontal portion 14 of the system 10, and can extend beyond the area where it intersects with the vertical portion 12. The transport tube 32 can be provided with an overall length and path that allows the core of material to move to a desired area in which it will be tested. Thus, the strength of the vacuum will generally be sufficient to pull the core along the desired length of the tube 32 at a desired speed that will not damage the core. Transport tube 32 can include one or more rigid segments (e.g., stainless steel tubing segments) and/or one or more flexible segments (e.g., flexible hose material segments). In an exemplary embodiment, the transport tube 32 includes a combination of straight segments made of a rigid tube material and curved segments made of a flexible, hose-like material, such as synthetic rubber or plastic that may optionally be reinforced with various materials to help the hose segment to maintain a desired shape and curvature. The curvature of any curved segments of the transport tube 32 are configured to be able to accommodate a certain specified length of a core of material that will be transported through it.

In operation, the coring system 10 is used for sampling biomass from bales of biomass material and transporting those cores or samples from the bales sitting on flatbed truck trailers to a lab or other analysis area for testing. The systems of the invention can maintain the biomass samples within a pneumatic transport or conveyance tube 32 for the entire time from the insertion of the probe or corer 16 into the biomass to the receipt of the biomass sample or core by the testing facility. The corer 16 of the system is therefore compatible with pneumatic conveyance of the material, which is accomplished by the positioning of the inner tube 20 within the outer tube 18. At least a slight gap is provided between the outer and inner tubes 18, 20 in order to provide a steady and continuous supply of air at the cutting tip 22 to allow the removed core of material to be conveyed to a desired location. That is, the gap between the inner and outer tubes allows air to more freely to provide a steady air supply, which in turn allows the core of material to be conveyed to its final destination.

An embodiment of a coring system 10 of the invention includes a rotating corer 16 that is activated by a hydraulic motor. The end of the rotating corer 16 houses a tip that is specifically configured for cutting and penetrating a bale of biomass material. The tip may be removably affixed to the end of the corer, such as via a threaded connection, so that it can be easily removed and replaced, as desired, such as for replacement or sharpening of the cutting teeth at the distal end. The rotating corer 16 can be held in place by pillow block bearings, and the assembly can be attached to a hydraulically controlled arm that allows a remote operator to position the corer 16 over a bale that is ready to be tested. The arm is then lowered while the corer 16 continues to rotate, thereby allowing the rotating corer 16 to penetrate the biomass material bale.

As the corer 16 penetrates the biomass bale, the biomass is loosened and a pneumatic airstream is able to remove the biomass material via vacuum. The material is then moved to a transport line and cyclone to a technician who can then perform testing and analysis on the removed core of biomass material. With such a system, it is possible to remotely sample a biomass bale and deliver the material to a technician that is located in another nearby location, such as a scale house.

In order to utilize a coring system, such as one of the embodiments of such a system described above, a coring system is provided in an area where truckloads with bales of biomass are transported. Although biomass bales are commonly transported on the back of a flatbed of a truck, it is possible for the bales to be presented to the coring system in a number of different ways. For an example, bales can be transported in the back of an enclosed truck, or bales can be removed from a truck via a means of transporting bales, such as a conveyance system, for example, and moved into the area in which the coring system can be used for sampling the bales. The desired location or locations on the bale from which one or more material samples are to be removed are identified, and the coring system and/or the bale locations can be adjusted, if necessary, so that the tip of the corer is able to contact and penetrate the bale at the desired location(s).

The corer is then activated so that it can begin to rotate, such as by an operator or by an automatic control system, and then its movement is controlled by the same or a different operator in order to force the cutting tip into the biomass bale. The specific systems and mechanisms used to control the movement of the corer can vary, but may include a touch-screen panel, one or more joysticks, switches, slides, buttons, combinations of various control mechanisms, and the like. The rotating corer can then be lowered or moved in another direction toward the bale until the corer penetrates the biomass material bale by a desired amount. As the corer penetrates the bale, the biomass is loosened and a core of biomass material is created that is enclosed within the corer. The corer can penetrate up to 20 inches deep, for example. A pneumatic airstream removes the biomass material core via vacuum and moves it into the transport line or hose. The core of material can then be moved along the transport line to a location where a technician can access the core for analysis thereof. The above process can be repeated as many times as is desired for a particular bale by moving the coring system until the corer is positioned adjacent to each desired testing location.

While biomass is discussed throughout the description of the coring systems of the invention, it is understood that the coring systems can alternatively be used with other materials, such as other materials provided in bale form and/or materials configured in different forms than bales.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A core sampling system for removing sample cores of material from biomass bales, the system comprising:
a base member;
a supporting member extending from and moveable relative to the base member;
a rotating corer extending from the supporting member, wherein the corer comprises:
a first elongated tube at least partially surrounding a second elongated tube; and
a distal tip extending from a distal end of the second elongated tube; and
a transport tube in communication with an inner area of the second elongated tube.

2. The core sampling system of claim 1, wherein the rotating corer is controlled with a hydraulic motor.

3. The core sampling system of claim 1, wherein the distal tip of the corer is removably attached to the distal end of the second elongated tube.

4. The core sampling system of claim 1, wherein the distal tip of the corer comprises a tapered outer surface.

5. The core sampling system of claim 1, wherein the distal tip of the corer comprises a plurality of cutting surfaces spaced from each other around a circumference of the corer.

6. The core sampling system of claim 1, wherein the supporting member comprises a hydraulically controlled elongated arm that is electrically controllable.

7. The core sampling system of claim 1, wherein the transport tube comprises at least one rigid portion and at least one flexible portion.

8. A method of extracting samples of biomass material from biomass bales, comprising the steps of:
positioning a coring system adjacent to a biomass bale, the coring system comprising:
a base member;
a supporting member extending from and moveable relative to the base member;
a rotating corer extending from the supporting member, wherein the corer comprises:
a first elongated tube at least partially surrounding a second elongated tube; and
a distal tip extending from a distal end of the second elongated tube; and
a transport tube in communication with an inner area of the second elongated tube;
activating the coring system so that the rotating corer rotates;
moving the corer toward the biomass bale until the corer contacts the bale;
penetrating the bale with the corer to a specified depth, thereby producing a biomass sample core; and
transporting the biomass sample core to a testing location.

9. The method of claim 8, wherein the rotating corer is controlled with a hydraulic motor.

10. The method of claim 8, wherein the distal tip of the corer is removably attached to the distal end of the second elongated tube, and further comprising the step of removing a first distal tip and replacing it with a second distal tip.

11. The method of claim 8, wherein the distal tip of the corer comprises a tapered outer surface.

12. The method of claim 8, wherein the distal tip of the corer comprises a plurality of cutting surfaces spaced from each other around a circumference of the corer.

13. The method of claim 8, wherein the supporting member comprises a hydraulically controlled elongated arm that is electrically controllable.

14. The method of claim 8, wherein the transport tube comprises at least one rigid portion and at least one flexible portion.

15. The method of claim 8, wherein the step of positioning the biomass bale comprises moving the bale to the coring system.

16. The method of claim 15, wherein the biomass bale is moved using a conveyance system.

17. The method of claim 8, wherein the step of positioning the biomass ball comprises moving the coring system to the biomass bale.
